(19) United States
(12) Patent Application Publication
(10) Pub. No.: US 2026/0004309 A1
(43) Pub. Date: Jan. 1, 2026

(54) SYSTEM AND METHOD FOR DETERMINING TRUST INDICATORS

(71) Applicant: Actimize Ltd., Ra'anana (IL)

(72) Inventors: Danny BUTVINIK, Haifa (IL); Carl KEMMERER, Hoboken, NJ (US)

(73) Assignee: Actimize Ltd., Ra'anana (IL)

(21) Appl. No.: 18/758,683

(22) Filed: Jun. 28, 2024

(51) Int. Cl. G06Q 30/018; G06Q 10/0635

(52) U.S. Cl. CPC G06Q 30/018; G06Q 10/0635

(57) ABSTRACT

A system and method for determining trust indicators of legal entities may determine coefficients for a plurality of risk factors for a legal entity, wherein said risk factors indicate risks associated with one or more of: said legal entity taking part in a transaction and said legal entity's transaction type, and wherein said coefficients determine a relative impact of each of said plurality of risk factors in the calculation of a risk score for said legal entity; calculate said risk score from coefficients and risk factors; assess data incompleteness for values of said plurality of risk factors and calculate a data incompleteness score; and generate a trust indicator for said legal entity from said risk score and data incompleteness score.

### TECHNICAL FIELD OF THE INVENTION

The present invention relates generally to the determination of trust indicators of legal entities, more specifically to the determination of trust indicators based on datasets which take into account data incompleteness of datasets in the generation of such trust indicators.

### BACKGROUND OF THE INVENTION

When assessing the trustworthiness of legal entities, analysts typically rely on static indicators such as transaction patterns and historical data to assess and manage risk. While these methods have served the industry for a considerable period, they are increasingly seen as inadequate as they fail to capture the ever-evolving nature of crime.

Risk assessment and management have become more important as the linchpin that protects institutions from crime while ensuring operational integrity. Despite the functionality of existing frameworks, there remains a deficiency in predicting the intricate dynamics of risk or trust for legal entities.

Thus, there is a need for a solution that allows for the determination of accurate trust indicators for legal entities.

### SUMMARY OF THE INVENTION

Improvements and advantages of embodiments of the invention may include automatically generating a trust indicator for assessing a legal entity that combines risk factors and assesses the quality of data present in the risk factors by determining a data incompleteness score. Embodiments may more accurately determine a trust indictor for a legal entity.

In one aspect, the present invention allows the incorporation of a plurality of various risks scores, e.g. International Standardization Organization (ISO) standards and industry norms, in the calculation of a trust indicator for a legal entity.

In another aspect, the present invention allows independently determining the relative impact of risk factors and data incompleteness in the generation of trust indicators, e.g. by providing a more adaptive risk assessment framework responsive to developments in the conduction of financial crime compared to existing methodologies that depend on predefined rules and thresholds.

Embodiments may allow adapting the generation of a trust indicator by determining equation coefficients utilizing advanced machine learning optimization techniques, notably using genetic algorithms based on training datasets.

One embodiment may include a method of determining trust indicators, the method including: determining coefficients for a plurality of risk factors for a legal entity, wherein the risk factors indicate risks associated with one or more of: the legal entity taking part in a transaction and the legal entity's transaction type, and wherein the coefficients determine a relative impact of each of the plurality of risk factors in the calculation of a risk score for the legal entity; calculating the risk score from coefficients and risk factors; assessing data incompleteness for values of the plurality of risk factors and calculating a data incompleteness score; and generating a trust indicator for the legal entity from the risk score and data incompleteness score.

In one embodiment, when the trust indicator is <than a threshold value, blocking the legal entity associated with the trust indicator from executing a transaction.

In one embodiment, when the trust indicator is >=than a threshold value, permitting the legal entity associated with the trust indicator to execute a transaction.

In an embodiment, the coefficients are updated by submitting previously recorded combinations of coefficients and risk scores to a machine learning (ML) model and retrieving updated coefficients.

In an embodiment, the ML model is trained by operations including: receiving, by a processor, training datasets including training coefficients, training risk factors and training trust indicators; and training, by the processor, the ML model using the training datasets to determine the training coefficients from the training trust indicators and the training risk.

In an embodiment, the updating of the coefficients via the ML model includes submission of previously recorded combinations of coefficients and risk scores to a ML model including a linear regression model.

In an embodiment, the trust indicator (TS) is calculated from the risk score (RS) and the data incompleteness score (DI) according to equation I:

$$= ( 100 - RS ) \cdot ( 1 - DI ) \qquad Equation I$$

In one embodiment, the plurality of risk factors includes one or more entity risk factors (E_{RF}) and one or more enhanced due diligence risk factors (EDD_{RF}) and the risk score (RS) is calculated according to equation II:

$$RS = {coeff}_{ER}^{w} \cdot {E}_{RF} + {coeff}_{EDD}^{w} \cdot {EDD}_{RF} \qquad Equation II$$

wherein:
   RS is the risk score to be determined;
   E_{RF} is an array of the one or more entity risk factors;
   EDD_{RF} is an array of the one or more enhanced due diligence risk factors; and

$${coeff}_{ERF}^{w} and {coeff}_{DDRF}^{w}$$

are coefficients for the respective risk factors.

In one embodiment, determining trust indicators includes: calculating the E_{RF} and EDD_{RF} arrays; creating a feature matrix from the E_{RF} and EDD_{RF} arrays; converting the feature matrix into a 2-dimensional array; and constructing a target vector containing the trust score.

One embodiment includes evaluating the trust indicator using an evaluation metric selected from a group consisting of mean squared error, root mean squared error (RMSE) and r-squared error.

One embodiment may include a system for determining trust indicators of legal entities, the system including: a computing device; a memory; and a processor, the processor configured to: determine coefficients for a plurality of risk factors for a legal entity, wherein the risk factors indicate risks associated with one or more of: the legal entity taking part in a transaction and the legal entity's transaction type, and wherein the coefficients determine a relative impact of each of the plurality of risk factors in the calculation of a risk score for the legal entity; calculate the risk score from coefficients and risk factors; assess data incompleteness for values of the plurality of risk factors and calculate a data incompleteness score; and generate a trust indicator for the legal entity from the risk score and data incompleteness score.

One embodiment may include a method of generating trust indicators for actions of corporate bodies, the method including: determining weights for a plurality of risk factors for a corporate body, wherein the risk factors indicate risks associated with one or more of: the corporate body taking part in a transaction and the corporate body's transaction type, and wherein the weights determine a relative impact of each of the plurality of risk factors in the calculation of a risk score for the corporate body; calculating the risk score from weights and risk factors; identifying data completeness for values of the plurality of risk factors and calculating a data completeness score; and generating a trust indicator for the corporate body from the risk score and data completeness score.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is a schematic drawing of a system for determining trust indicators, according to some embodiments of the invention.

FIG. 3 depicts a flowchart of methods of determining trust indicators, according to some embodiments of the present invention.

FIG. 4 is a high-level block diagram showing exemplary generation of a trust indicator from entity risk factors and enhanced due diligence risk factors, according to some embodiments of the present invention.

FIG. 5 is a high-level block diagram showing exemplary input in form of entity risk factors to a ML model and output of a ML model in form of a trust indicator, according to some embodiments of the invention.

FIG. 6 is a visual representation of a risk score (overall risk) in relation to data incompleteness score (overall ID) and trust indicator (trust score), according to some embodiments of the present invention.

FIG. 7 is an illustration of a linear relationship between trust indicator in relation to data incompleteness score for a legal entity, according to some embodiments of the present invention.

FIG. 8 is a schematic illustration of a first detection flow for data items used in the generation of risk factors, according to some embodiments of the present invention.

FIG. 9 is a schematic illustration of a second detection flow for data items used in the generation of risk factors, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “legal entity” may refer to an organization that has legal rights and obligations, including the ability to enter contracts, sue and be sued, and own property. Examples of legal entities may include corporations, limited liability companies and non-profit organizations.

As used herein “trust indicator” or “trust score” may refer to a value that indicates a trustworthiness of a legal entity, or the level of risk that a party may have when performing operations in conjunction with that legal entity. This may be in various contexts, such as for example when transferring data, exchanging data, or conducting financial business, e.g. a financial transaction. An example trust indicator for a legal entity may have a value between 0 and 100, wherein a low value, e.g. 10, indicates low trustworthiness and a high value, e.g. 80, indicates high trustworthiness. Other ranges may be used; and trust indicators in other contexts may be used.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms.

ML models may, for example, include Large Language Models (LLM) such as Generative Pre-Trained Transformer (GPT), Bidirectional Encoder Representations from Transformers (BERT), Pathways Language Model (PaLM) and the like, (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

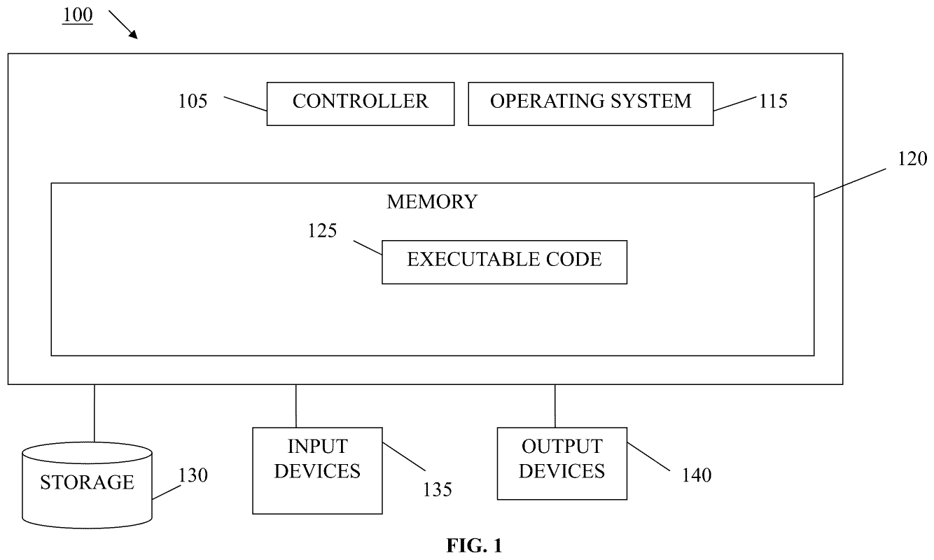

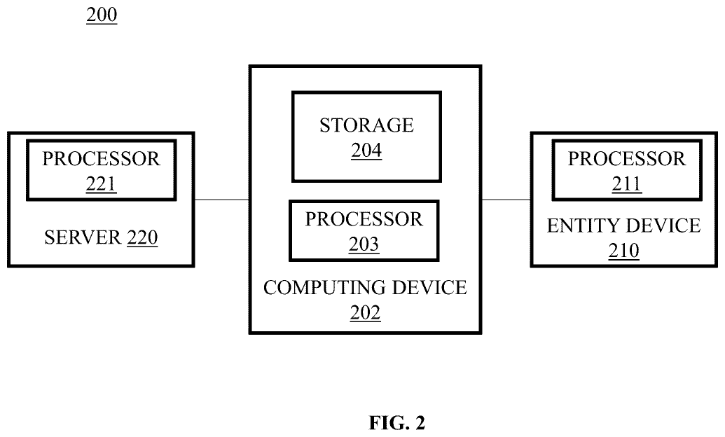

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules and equipment and other devices and modules discussed herein, e.g. computing device 202, legal entity device 210, device 220, input engine 502, platform engine 504, and modules and processes in FIGS. 2, 3, 4, 5, 8, 9 may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

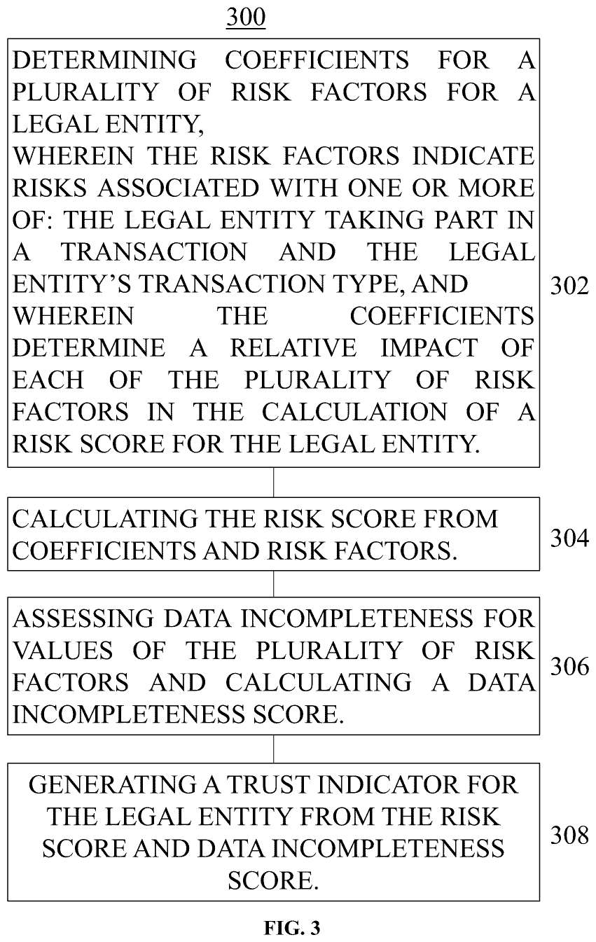

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 3 or other figures, or other methods, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

FIG. 2 is a schematic drawing of a system 200 according to some embodiments of the invention. System 200 may include a computing device 202 including a processor 203 and storage 204. Computing device 202 may be connected to a legal entity device 210 that includes processor 211. Computing device 202 may be connected to a server 220 including processor 221.

Computing devices 100, 202, 210 and 220 may be servers, personal computers, desktop computers, mobile computers, laptop computers, and notebook computers or any other suitable device such as a cellular telephone, personal digital assistant (PDA), video game console, etc., and may include wired or wireless connections or modems. Computing devices 100, 202, 210 and 220 may include one or more input devices, for receiving input from a user (e.g., via a pointing device, click-wheel or mouse, keys, touch screen, recorder/microphone, or other input components). Computers 100, 202, 210 and 220 may include one or more output devices (e.g., a monitor, screen, or speaker) for displaying or conveying data to a user.

Any computing devices of FIGS. 1 and 2 (e.g., 100, 202, 210, and 220), or their constituent parts, may be configured to carry out any of the methods of the present invention. Any computing devices of FIGS. 1 and 2, or their constituent parts, may include input engine 502, platform engine 504, or another engine or module, which may be configured to perform some or all of the methods of the present invention. Systems and methods of the present invention may be incorporated into or form part of a larger platform or a system/ecosystem, such as agent management platforms. The platform, system, or ecosystem may be run using the computing devices of FIGS. 1 and 2, or their constituent parts. For example, a processor such as processor 203 of computing device 202 and/or processor 211 of device 210 may be configured to determine coefficients for a plurality of risk factors for a legal entity, wherein the risk factors indicate risks associated with one or more of: the legal entity taking part in a transaction and the legal entity's transaction type, and wherein the coefficients determine a relative impact of each of the plurality of risk factors in the calculation of a risk score for the legal entity. For example, a processor such as processor 203, 211 and/or 221 may be configured to determining weights for a plurality of risk factors for a corporate body such as company A or company B.

Weights may indicate a prioritization of risk factors in the generation of a risk score. For example, when a risk score is calculated from risk factors A, B and C and risk factor A has a weight of 0.5, risk factor B has a weight of 0.1 and risk factor C has a weight of 0.4, a risk score generated from all three risk factors may be predominantly influenced by risk factors A and C having a weight of 0.5 and 0.4, and may only be minorly affected due to a change in value of risk factor B (lowest weight of 0.1). A processor such as processor 203 of computing device 202 processor 211 of device 210, and/or processor 221 of computing device 220 may be configured to calculate a risk score from coefficients, e.g. weights, and risk factors. For example, a processor such as processor 203, 211 and/or 221 may be configured to calculate a risk score from weights and risk factors such as country of incorporation, residential postal code and entity subtype. A processor such as processor 203 of computing device 202 processor 211 of device 210, and/or processor 221 of computing device 220 may be configured to assess data incompleteness for values of the plurality of risk factors and calculate a data incompleteness score. For example, a language model may be configured to identify data completeness for values of the plurality of risk factors, e.g. data completeness for risk factors such as incorporation date and legal form, and to calculate a data completeness score, e.g. a data completeness score in a range between 0 and 100 such as 20. A processor such as processor 203 of computing device 202 processor 211 of device 210, and/or processor 221 of computing device 220 may be configured to generate a trust indicator for the legal entity from the risk score and data incompleteness score. For example, a processor such as processor 203, 211 and/or 221 may be configured to generate a trust indicator for a corporate body. A processor such as processor 203 of computing device 202 may be configured to retrieve risk factors from a database, e.g. a processor may retrieve a risk factor country of residence such as an ISO3166-Alpha-2 code for legal entity A from a database. A processor such as processor 203 of computing device 202 may be configured to transform a risk category into a value of a risk factor. For example, a processor may retrieve a risk factor country of residence in form of a country associated with a risk category, e.g. country Albania risk category high and may transform a risk category into a value of a risk factor, e.g. a value “100” for country Albania having a high risk category.

FIG. 3 shows a flowchart of a method 300 of determining trust indicators, e.g. an indicator for the trustworthiness associated with a legal entity such as a business operated by an individual, a corporation or a limited liability company (LLC). The trust indicator may, for example, indicate a trustworthiness of a legal entity for conducting a transaction, e.g. a financial transaction, or any other form of business activity, e.g. a trade agreement. The system displayed in FIG. 2 and the method shown in FIG. 3 may refer to the determination of trust indicators used for estimating one or more future transaction events based on the calculation of a risk score from risk factors and a data incompleteness score from risk factors or lack thereof for a legal which have been received from a legal entity device, e.g. 210, a database, e.g. server 220, however, the system and the method may also be used to generate a trust indicator for a legal entity when executed on a server or an entity device. According to some embodiments, some or all of the steps of the method are performed (e.g., fully or partially) by one or more of the computational components, for example, those shown in FIGS. 1 and 2.

In operation 302, coefficients for a plurality of risk factors for a legal entity may be identified, wherein the risk factors indicate risks associated with one or more of: the legal entity taking part in a transaction and the legal entity's transaction type, and wherein the coefficients determine a relative impact of each of the plurality of risk factors in the calculation of a risk score for the legal entity. A coefficient may be a value between 0 and 1, e.g. 0.05, 0.10, 0.20 or may be a percentage value between 0% and 100%, e.g. 5%, 10%, 20% or 25%, etc. Other ranges or units may be used. A transaction type may be a financial transaction, e.g. a transfer of money between legal entity A and legal entity B, a trade agreement to trade goods from legal entity A to legal entity B or an agreement to receive goods from legal entity A for a sum of money paid to legal entity B. A risk score may be calculated from a plurality of risk factors, e.g. 9 entity risk factors such as country of incorporation, country of residence, residence postal code, entity subtype, primary North American Industry Code (NAIC), incorporation date, legal form, ownership complexity or product category. However, a calculation of a risk score may proceed via a subgroup of the 9 entity risk factors (E_{RF}), e.g. 1, 2, 3, 4, 5, 6, 7, or 8 of the entity risk factors or additional risk factors known in the art. A risk score may be calculated from a plurality of risk factors, e.g. 4 enhanced due diligence factors (EDD_{RF}) such as enhanced due diligence trigger, sanctions outcome, PEP outcome, or adverse media outcome. However, a calculation of a risk score may proceed via a subgroup of the 4 due diligence risk factors, e.g. 1, 2 or 3 of the entity risk factors or additional risk factors known in the art. A calculation of a risk score may proceed via combination of one or more entity risk factors and one or more enhanced due diligences factors. For example a risk score may be calculated from 9 entity risk factors (E_{RF}) and 4 enhanced due diligence risk factors (EDD_{RF}).

Each risk factor may be assigned to a coefficient, e.g. entity risk factor “resident postal code” may be assigned to a risk factor “0.10”. Other ranges for risk factors may be used. Coefficients may indicate a weight of a risk factor value in relation to all risk factors in the calculation of a risk score. For example, in case that three risk factors are identified for an entity A, B and C, each risk factor may be assigned a coefficient, e.g. risk factor A: 0.25, risk factor B: 0.7 and risk factor C: 0.05. In this example scenario, risk factor B, has the highest weight among all other risk factors. Weighting of risk factors may be important, e.g. when it is known that a specific risk factor provides a precise or negligible indication for a risk score. E.g. a risk factor resident postal code A retrieved from a database from the year 2023 may be a more recently received risk factor than a risk factor resident postal code B retrieved from a database from the year 2000. Thus, in the calculation of a risk score, risk factor A may have a weight that is higher than risk factor B.

In operation 304, a risk score may be calculated from coefficients and risk factors. For example, a plurality of risk factors includes one or more E_{RF}s and one or more EDD_{RF}s and the risk score (RS) may be calculated according to equation II:

$$RS = {coeff}_{ER}^{w} \cdot {E}_{RF} + {coeff}_{EDD}^{w} \cdot {EDD}_{RF} \qquad ( Equation II )$$

wherein:
   RS is the risk score to be determined;
   E_{RF} is an array of the one or more entity risk factors;
   EDD_{RF} is an array of the one or more enhanced due diligence risk factors; and

$${coeff}_{ERF}^{w} and {coeff}_{DDRF}^{w}$$

are coefficients for the respective risk factors.

Coefficients for risk factors and/or the calculation of a data incompleteness score may be updated, e.g. via a ML model. For example, previously recorded combinations of coefficients and risk scores may be input to a ML model including a linear regression model. A ML model used to update coefficients for risk factors and/or the calculation of a data incompleteness score may be trained, e.g. by an operation of receiving, by a processor, training datasets including training coefficients, training risk factors and training trust indicators; and training, by the processor, the ML model using the training datasets to determine training coefficients from training trust indicators and training risk factors. For example, coefficients may be updated by submitting previously recorded combinations of coefficients and risk scores to a ML model and retrieving updated coefficients. For example, coefficients may be decreased, e.g. reduced in their impact in cases when risk factors or data incompleteness factors for a legal entity are outdated, e.g. older than 2 years.

In operation 306, data incompleteness for values of a plurality of risk factors may be assessed and a data incompleteness score may be calculated. For example, data incompleteness for values of a plurality of risk factors may be assessed, e.g. by detecting incomplete or missing data items or values for a specific risk factor. For example, a data incompleteness score may be calculated for entity risk factors and due diligence factors by example equation III:

$$D I = ( {coeff}_{ER}^{w} \cdot {\sum }_{p ∈ U}^{\vert U \vert} {w}_{p}^{ER} + {coeff}_{EDD}^{w} \cdot {\sum }_{m ∈ Z}^{\vert Z \vert} {w}_{m}^{EDD} ) / 100 \qquad ( Equation III )$$

where, |U| and |Z| may be defined as:
   |U|={p|RFₚ=0} cardinality of entity risk factors whose values are missing, and
   |Z|={m|RFₘ=0} cardinality of enhanced due diligence risk factors whose values are missing. The variable w may be the weight of a data incompleteness for an entity risk factor (w^{ER}) or due diligence factor (w^{EDD}). Variables m and p may be integer values that represent the number of a specific entity risk factor (variable p) or a due diligence factor (variable m).

For example, EDD risk factors may have three different values: When an EDD_{RF} for a legal entity is present, e.g. has been detected in a database, a value of “30” is assigned to such an EDD_{RF}. When a legal entity does not have a EDD_{RF} value, a value of “0” is assigned to such an EDD_{RF}. When it is unknown whether or not a legal entity has a EDD_{RF} value, a value of “30” may be assigned to such an EDD_{RF}. For example, when a risk factor “EDD trigger” for entity X is unknown, a weight of this risk factor may be added to the value “30” for an unknown EDD_{RF} value, e.g. if a weight for an EDD_{RF} “EDD trigger” is 0.3, the value of “30” may be multiplied with the value 30.

In operation 308, a trust indicator for the legal entity from the risk score and data incompleteness score may be generated.

For example, a trust indicator (TS) may be calculated from a risk score (RS) and a data incompleteness score (DI) according to example equation I:

$$= ( 100 - R S ) \cdot ( 1 - D I ) \qquad ( Equation I )$$

For example, when a trust indicator is <than a threshold value, a legal entity associated with the trust indicator may be blocked from executing a transaction. For example, when a trust indicator is >=than a threshold value, a legal entity associated with the trust indicator may be permitted to execute a transaction. For example, a threshold value for a trust indicator may be 50 and a legal entity having a trust indicator<50 (such as 35) may be blocked from executing a transaction, and a legal entity having a trust indicator>=50 (such as 85) may be permitted to execute a transaction.

In some embodiments, determining trust indicators may include: calculating the E_{RF} and EDD_{RF} arrays; creating a feature matrix from the E_{RF} and EDD_{RF} arrays; converting the feature matrix into a 2-dimensional array; and constructing a target vector containing the trust score. For example, a 2-dimensional array may have a format of [(1,2), (3,4)].

Following the generation of a trust indicator for a legal entity from a risk score and a data incompleteness score, a trust indicator may be evaluated. For example, a trust indicator may be evaluated using an evaluation metric such as mean squared error, root mean squared error (RMSE) and r-squared error.

Operations 302, 304, 306 and 308 may be performed for the generation of a trust indicator for one legal entity at a time based on the provided risk factors and calculated risk scores and data incompleteness scores, but may also be performed for multiple legal entities at a time, e.g. concurrently in parallel. Initiation of operations 302, 304, 306 and 308 may occur periodically, e.g. generation of a trust indicator for a legal entity may every 20 seconds, every minute, or may occur when a transaction event for a legal entity is detected.

A plurality of risk factors may include one or more entity risk factors E_{RF}s and one or more enhanced due diligence risk factors EDD_{RF}s.

Risk factors may be variables which can affect the stability performance and compliance of a legal entity. These factors can include financial health, regulatory compliance, market conditions, management practices and operational efficiency.

Entity risk factors may be factors which can affect the stability, performance and compliance of a legal entity over its lifetime. Entity risk factors may relate to ongoing operations and existence of an entity, e.g. they may encompass broad continuous aspects such as financial stability, market conditions, regulatory compliance.

Enhanced due diligence risk factors may include specific considerations and verifications of legal entities, e.g. the determination whether or not a legal entity is a politically exposed person or whether or not a legal person is affected by trade sanctions, performed during a particular transaction and may include detailed examination of an entity's financial records, legal obligation and overall suitability for the transaction in question, e.g. to identify and mitigate risks associated with a specific transaction.

Enhanced due diligence factors, in the context of financial crime, may involve an assessment of legal entities to mitigate potential legal, financial, and reputational risks associated with money laundering, terrorism financing, and other illicit activities. Enhanced due diligence factors may be triggered when legal entities exhibit risk factors such as operating in high-risk jurisdictions, involvement in high-risk industries (like gambling or arms trading) or exhibiting unusual transaction patterns. This process may include gathering detailed information about a legal entity's ownership structure, source of funds, the purpose of the business relationship, and ongoing monitoring to ensure that the entity's activities align with the risk profile initially determined.

Risk factors for transactions may be identified, for example, from ISO standards, including but not limited to ISO 3166-1-Alpha-2, ISO 31000, ISO 19600, and ISO/IEC 27001, alongside the evaluation of frameworks such as High-Intensity Financial Crime Areas (HIFCA) and codifications including the NAIC.

Coefficients may be added to risk factors, e.g. E_{RF}s and/or EDD_{RF}s, to determine a relative impact of each of the plurality of risk factors in the calculation of a risk score for the legal entity and/or calculating the data incompleteness score from coefficients and risk factors.

An entity risk factor (E_{RF}) “country of incorporation” may refer to a risk factor which is based on the jurisdiction where the entity is officially registered and operates. This factor may utilize an ISO3166-1-Alpha-2 code to represent the country, which is a two-letter country code standard to denote the principal subdivisions of a country. A weight which may be initially assigned to this factor may be 10%, indicating its significant role in determining an entity's risk score. The country of incorporation can influence the risk score based on the jurisdiction's regulatory environment, economic stability, and prevalence of financial crimes.

An E_{RF} “country of residence may represent the country where the entity primarily conducts its business or where its main office is located. Like the country of incorporation, it can use an ISO3166-1-Alpha-2 code for its representation. A weight which may be initially assigned to this risk factor may be 5%, reflecting its role in the risk assessment but to a lesser extent than the country of incorporation. The country of residence can provide insights into the entity's operational environment and its regulatory landscape.

An E_{RF} “country of residence postal code” may take into account the specific postal code of the entity's country of residence, focusing on High-Intensity Financial Crime Areas (HIFCA). HIFCA regions may be designated as high-risk areas for financial crimes, and is in such an area can potentially elevate the entity's risk score. A weight which may be initially assigned to this risk factor may be 5%, indicating its moderate influence on the overall risk score.

An E_{RF} “entity subtype” may be determined by Subject Matter Experts (SMEs), a specialist in financial crime domain. This factor may categorize entities into various subtypes based on criteria established by SMEs, e.g. considering the nature of the business, its operations, and other relevant characteristics. A weight which may be initially assigned to this factor may be 15%, indicating its significant role in determining an entity's risk score.

An E_{RF} “Primary North American Industry Code (NAIC)” may categorize an entity based on the North American Industry Classification System (NAICS), which classifies businesses into industry sectors based on their primarily engaged activities. The NAICS code can provide insights into the industry-specific risks associated with the entity. A weight which may be initially assigned to this factor may be 15%, indicating its significant role in determining an entity's risk score.

An E_{RF} “incorporation date” may be the date when an entity was legally formed and registered. This factor may indicate an entity's stability and experience in the industry, with older entities possibly having a more established operational history. A weight which may be initially assigned to this risk factor may be 5%, indicating its moderate influence on the overall risk score.

An E_{RF} “Legal form ISO 01-140-10” may refer to the legal structure of the entity, categorized according to the ISO 01-140-10 standard. Different legal forms can have varying levels of regulatory scrutiny and requirements, influencing the entity's risk profile. A weight which may be initially assigned to this factor may be 10%, indicating its significant role in determining an entity's risk score.

An E_{RF} “Ownership complexity” may be a structure and complexity of an entity's ownership. Complex ownership structures can sometimes obscure financial transactions and facilitate crimes, potentially influencing the risk score. A weight which may be initially assigned to this factor may be 20%, indicating its significant role in determining an entity's risk score.

An E_{RF} “product category” may categorize an entity based on the types of products which are offered by the entity. Different product categories may have varying risk levels, influencing the entity's risk score. A weight which may be initially assigned to this factor may be 15%, indicating its significant role in determining an entity's risk score.

Table 1 illustrates an example summary for a combination of coefficients for risk factors, e.g. initially defined by a subject matter expert (SME):

TABLE 1

| | |
|---|---|
| E_{RF} 1: Country of Incorporation | 10% |
| E_{RF} 2: Country of Residence | 5% |
| E_{RF} 3: Residence Postal Code | 5% |
| E_{RF} 4: Entity Subtype | 15% |
| E_{RF} 5: Primary NAIC | 15% |
| E_{RF} 6: Incorporation Date | 5% |
| E_{RF} 7: Legal Form | 10% |
| E_{RF} 8: Ownership Complexity | 20% |
| E_{RF} 9: Product Category | 15% |
| | 100% |

Table 1 illustrates an example summary for a combination of weight for risk factors: Table 1 presents a comprehensive enumeration of E_{RF}s, each accompanied by its respective weight. These weights have been established through a rigorous methodology involving advanced data-driven techniques drawn from data science, artificial intelligence, and machine learning, e.g. training datasets have been subjected to simulation procedures. These simulations may use optimization algorithms to identify and calibrate the optimal weightings for the risk factors.

Retrieved E_{RF}s may be categorized by values, low, medium, high and unknown. For example, a low E_{RF} value may be represented by a value of 10, a medium E_{RF} value may be represented by a value of 24, a high E_{RF} value may be represented by a value of 100 and an unknown E_{RF} value may be represent by a value of 0.

An enhanced due diligence risk factor (EDD_{RF}) “EDD Triggers” may encompass various triggers or indicators that necessitate a more detailed and rigorous due diligence process. Triggers and indicators which may be used in the generation of a EDD_{RF} EDD Triggers may include for an entity, for example: cash intensive gaming, games of chance, online gaming, fire arms, digital currencies, digital currency exchange, money service business, remittance, bearer shares, no trigger/indicators, or unknown. These triggers can involve sudden changes in the entity's financial behavior, associations with high-risk individuals or entities, or other indicators which signal a higher risk profile. The specific criteria and weight for this factor in the risk assessment will be established in the future, aiming to promptly identify and respond to significant risk indicators. A weight which may be initially assigned to this risk factor may be 10%, indicating its moderate influence on the overall risk score.

An EDD_{RF} “Sanctions Outcome” factor may represent outcomes or results of sanctions screenings conducted on the entity. An EDD_{RF} “Sanctions Outcome” factor may be identified as a potential match, e.g. when a sanction is imposed on an entity; an immaterial match, or a material match, no match, or unknown. Sanctions screenings may be essential in identifying any sanctions imposed on an entity by regulatory bodies, which can significantly impact the entity's risk score. The sanctions outcome may involve evaluating the nature and severity of any sanctions, the regulatory bodies involved, and the entity's response to such sanctions. A weight which may be initially assigned to this factor may be 20%, indicating its significant role in determining an entity's risk score.

An EDD_{RF} “Politically Exposed Person (PEP) Outcome” may assess an entity's association with individuals holding significant public functions, which can increase the risk of exposure to bribery, corruption, and other financial crimes. A PEP outcome may be identified as a potential match, an immaterial match, a material match, a material match—PEP1, a material match—PEP2, a material match—PEP3, a material match—PEP4, no match, or unknown. A PEP outcome can evaluate the level of exposure and the measures taken by the entity to mitigate associated risks. A weight which may be initially assigned to this risk factor may be 15%, indicating its moderate influence on the overall risk score.

A EDD_{RF} “Adverse Media Outcome” may represent the results of adverse media screenings conducted on the entity. An adverse media outcome may be based on no match, a potential match, an immaterial match, a material match or unknown. Adverse media screenings can involve scrutinizing various media sources to identify any negative news or information related to the entity, which can indicate a higher risk profile. The adverse media outcome can involve evaluating the severity and credibility of adverse media reports and their implications on the entity's reputation and risk profile. A weight which may be initially assigned to this risk factor may be 5%, indicating its moderate influence on the overall risk score.

Table 2 illustrates an example set of enhanced due diligence risk factors (EDD_{RF}), each EDD_{RF} accompanied by its respective coefficient. While not explicitly attributed to subject matter experts (SMEs), these weightings may be ascertained through a methodological process. In this process, a large-scale dataset, rich in labeled instances (or ground truth), underwent simulation using data science, artificial intelligence, and machine learning techniques.

Each of the EDD_{RF} may be subject to categorization into one of three distinct values: “Present,” “None,” or “Unknown.” These categorical designations may be subjected to label encoding, converting these categories into numeric representations: {30, 0, 30}.

Interpreting these categorical values may be relevant for an understanding of the underlying dynamics of EDD_{RF}s. Specifically, when a risk factor is denoted as “Present,” it may indicate the emergence of a suspicious status within the entity's profile. This suspicion can manifest across facets associated with Politically Exposed Persons (PEP) outcomes, involvement in gambling activities, or entanglement with sanction outcomes.

Conversely, when an EDD_{RF} value is “None,” it may indicate a scenario in which no element of suspicion is detected across any of the entity's risk factors. This state may indicate an uncompromised status, affirming that a legal entity is likely to be free from any observable risk or adverse indicators.

An EDD_{RF} value “Unknown” may indicate the presence of incomplete or missing data for a specific risk factor. This designation may allow identifying data incompleteness, e.g. leading to a hindering of a comprehensive assessment of the entity's risk profile. Consequently, “Unknown” may indicate an inherent information deficit within the risk assessment process.

Table 2 shows an example list of EDD_{RF}s and their coefficients.

TABLE 2

| | |
|---|---|
| EDD_{RF} 1: EDD Trigger | 10% |
| EDD_{RF} 2: Sanctions Outcome | 70% |
| EDD_{RF} 3: PEP Outcome | 15% |
| EDD_{RF} 4: Adverse Media Outcome | 5% |
| | 100% |

In some cases, e.g. when at least one of the EDD risk factors has a value of 30, an EDD_{RF} score may be calculated as the example sum of 70, which may represent a baseline, and a weighted summation of the EDD_{RF}s in question. These coefficients, assigned to the risk factors, may further disclose processes of the EDD_{RF} calculation, thereby enhancing the precision and granularity of the overall risk assessment process.

Table 3 illustrates an example conversion from risk categories to risk factor values for selected countries for a risk factor “Country of Residence”. For example, a legal entity residing, e.g. having their headquarters in a certain country, may have a high risk category. A risk category “high” may be assigned to an entity risk factor value 100. A legal entity residing, e.g. having their headquarters in Australia, may have a low risk category. A risk category “low” may be assigned to an entity risk factor value 10.

TABLE 3

| Country of Residence | Risk Category | Entity risk factor value |
|---|---|---|
| Albania | High | 100 |
| Algeria | High | 100 |
| American Samoa | Medium | 24 |
| . . . | . . . | . . . |
| Australia | Low | 10 |

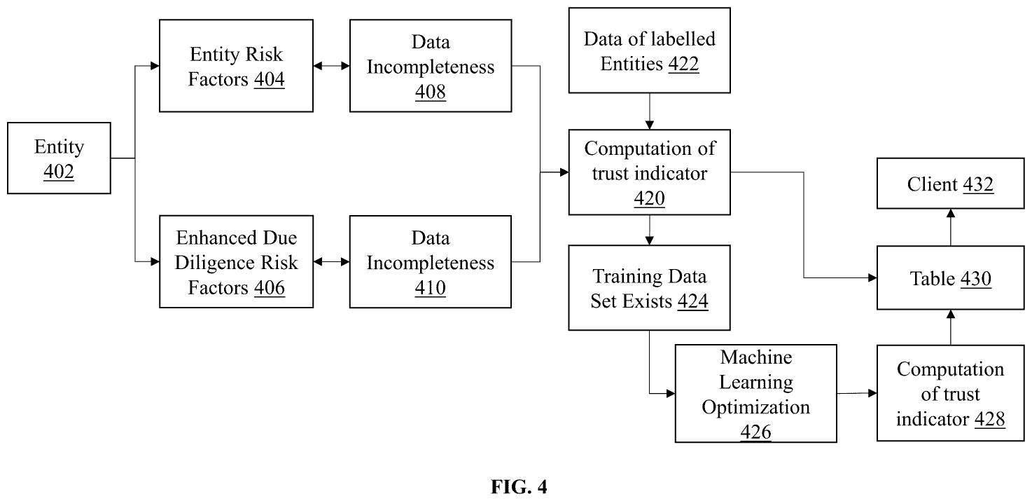

FIG. 4 is a high-level block diagram showing exemplary generation of a trust indicator from entity risk factors and enhanced due diligence risk factors, according to some embodiments of the present invention.

A plurality of risk factors may be retrieved for a legal entity 402, e.g. entity risk factors 404 and/or enhanced due diligence risk factors 406. Risk factors may be assessed in their data incompleteness. For example, data incompleteness in the form of missing values, e.g. a missing country of residence score for an entity located in Brazil, may be identified for each individual risk factors, e.g. data incompleteness 408 and 410 may be assessed for entity risk factors 404 and enhanced due diligence risk factors 406. Risk factors and determined coefficients for the risk factors may be used in the calculation of a risk score and data incompleteness, and determined coefficients may be used in the calculation of a data incompleteness score. Risk score (RS) and data incompleteness score (DI) may be used in the generation of a trust indicator 420 which may be provided as an output in form of table 430. Module data of labelled entities 422 may include training data, e.g. training datasets which include training coefficients, training risk factors and training trust indicators, for a legal entity. Module 422 may provide a ML model with training data which is correlated, e.g. labelled, to a trust indicator value. For example, a ML model may be trained to identify a trust indicator having a value of 60% as “not suspicious”. Training of a ML model may be performed with a plurality of training datasets which are labelled with risk indicators. In some cases, e.g. when coefficients for risk scores and data incompleteness scores are pre-determined or updated by submitting previously recorded combinations of coefficients to a machine learning (ML) model and retrieving updated coefficients, e.g. after training using a training dataset 424, trust indicators 428 may be calculated from updated coefficients retrieved after ML optimization of coefficients in operation 426.

Generation of a trust indicator 428, e.g. via computation using pre-defined coefficients or via coefficients updated by a ML model (operation 426) may result in a trust indicator 428 for a legal entity 402. Trust indicators 428 may be provided in form of a table, e.g. table 430, may have a value between 0 to 100, and may be provided as an output to a client 432.

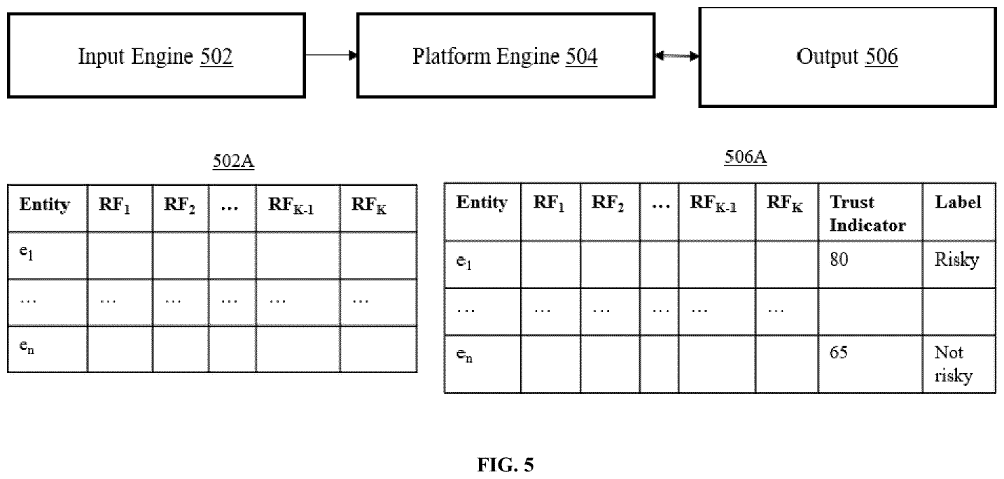

FIG. 5 is a high-level block diagram showing exemplary input in form of entity risk factors to a ML model and output of a ML model in form of a trust indicator, according to some embodiments of the invention. Input engine 502 may provide entity risk scores, e.g. in form of table 502A including entity risk scores RF₁ to RF_{K} for legal entities e₁ to eₙ to platform engine 504. Platform engine 504 may generate a trust indicator for each legal entity and may provide output 506, e.g. in the form of a trust indicator and a label, e.g. a label such as “risky” or “not risky”, for each legal entity e₁ to eₙ as shown in table 506A.

An entity risk factor score may be calculated according to example equation IV and may be the product of a coefficient coeff_{ER} multiplied by the sum of the product of individual entity risk factor values ERFᵢ (e.g. 9 entity risk factors i=1-9) and individual weights wᵢ for each entity risk factor value ERFᵢ.

$$ERFscore = {coeff}_{ER} \cdot {\sum }_{i = 1}^{9} E R {F}_{i} \cdot {w}_{i}^{ER} \qquad ( Equation IV )$$

Example equation V shows an example calculation of an enhanced due diligence factor (EDD_{RF} score). An EDD_{RF} score may be calculated by forming the product of a coefficient coeff_{EDD} multiplied by the sum of the product of individual entity risk factor values EDD_{RFi} (e.g. 9 entity risk factors i=1-9) and a weight wᵢ for each entity risk factor value EDDᵢ when |H|=0.

An EDD_{RF} score may be calculated by: “70” added to the product of a coefficient for an EDD_{RF} multiplied by the sum of the product of EDD_{RF} and weight for each EDD_{RF} when |H|>=1.

$$E D {D}_{RF} score \{ \begin{matrix}{coeff}_{EDD} \cdot {\sum }_{i = 1}^{4} E D {D}_{{RF}_{i}} \cdot {w}_{i}^{EDD} & if \vert H \vert = 0 \\ 70 + {coeff}_{EDD} \cdot {\sum }_{i = 1}^{4} E D {D}_{{RF}_{i}} \cdot {w}_{i}^{EDD} & if \vert H \vert \geq 1\end{matrix} \qquad ( Equation V )$$

A generation of a risk score (RS) may include the combination of two components: an entity risk factor and an enhanced due diligence factor. Both risk factors may be modified by specific weighting coefficients, denoted as coeff_{ER} and coeff_{EDD}.

The coefficient coeff_{ER}, assigned an example value of 0.7, may underline a contribution of an entity-specific risk assessment to the overall risk score (RS). Simultaneously, coeff_{EDD}, having a weight of 0.3, may indicate an impact of the EDD_{RF} risk assessment within the evaluation framework of a trust indicator.

Notably, a specific case may apply when an EDD_{RF} score has a value of zero: In such a case, coeff_{ER} may be assigned a value of 1. This condition may reflect a specific weighting schema designed to adapt to the absence of EDD_{RF} considerations.

This weighting of E_{RF} score and EDD_{RF} score may rely on methodologies which incorporate both mathematical and real-world feedback from a wide spectrum of financial institutions. It may combine the importance of entity-specific risk assessments and EDD_{RF} assessments in a manner that aligns with both empirical observations and the underlying principles of the risk evaluation process.

Example equation VI may illustrate a calculation of a risk score (RS) for a legal entity from an E_{RF} score and an EDD_{RF} score:

$$R S = {E}_{RF} score + E D {D}_{RF} score \qquad ( Equation VI )$$

The computation of a trust indicator may include an approach that includes not only E_{RF} score and EDD_{RF} score but may also incorporate a critical dimension known as data incompleteness score (DI). DI may quantify an extent of missing data within the risk factors, e.g. by signifying a percentage of unattainable and/or absent information.

To account for DI's influence on the overall risk score, a two-step approach may be applied: Firstly, DI may be calculated and scaled according to a risk factor. This DI-weighted entity risk factor E_{RF} score may be multiplied by a weighting coefficient,

$${coeff}_{ER}^{w} ,$$

set at 0.7. In parallel, the DI-adjusted EDD_{RF} score may undergo a similar treatment, being multiplied by a

$${coeff}_{EDD}^{w}$$

of 0.3.

This approach may take into account that DI may represent a critical dimension of uncertainty and information asymmetry, enabling an incorporation into the overall risk assessment paradigm.

The methodology employed to derive the DI weighting factors may be summarized by example equation VII. Example equation VII illustrates the calculation of a data incompleteness score DI based on coefficients such as

$${coeff}_{ER}^{w} and {coeff}_{EDD}^{w} :$$

$$D I = ( {coeff}_{ER}^{w} \cdot {\sum }_{p ∈ U}^{\vert U \vert} {w}_{p}^{ER} + {coeff}_{EDD}^{w} \cdot {\sum }_{mϵZ}^{\vert Z \vert} {w}_{m}^{EDD} ) / 100 \qquad ( Equation VII )$$

where |U| and |Z| are defined as:
   |U|={p|RFₚ=0} cardinality of entity risk factors whose values are missing,
   |Z|={m|RFₘ=0} cardinality of EDD risk factors whose values are missing.

Example equation VIII illustrates a generation of a trust indicator TS from a RS and DI:

$$T S = ( 100 - R S ) \cdot ( 1 - D I ) \qquad ( Equation VIII )$$

Trust indicator (TS) may be a singular metric designed to assess the degree of trustworthiness associated for a legal entity. Elevated values of a trust indicator may signify an increased level of trustworthiness, e.g. a trust indicator between an example range of 70 and 100 such as 90, moderate trustworthiness may be represented by a trust indicator, between an example range of 50 to 70 such as 65. A low trustworthiness level may be represented by a trust indicator between an example range of 0 and 50 such as an example trust indicator value of 10.

Mathematical validation may ensure the equation's stability and coherence through quantitative techniques: The process involved assessing a spectrum of risk factors for enhanced due diligence, ranging from geographical to industry-specific dynamics, in line with the guidelines provided by pertinent ISO standards. This process may allow the provision of a trust indicator based on equations which can withstand diverse scenarios and reflect the risk associated with different legal entities.

Example equations IX and X show a derivation of a trust indicator in relation to RS and in relation to ID. As shown in example equation IX, a negative sign may indicate an inverse relationships: a high Totalᵣᵢₛₖ may lead to a low TS:

$$\frac{{\partial }_{TS}}{{\partial }_{RS}} = - 1 \cdot ( 1 - D I ) \qquad ( Equation IX )$$

As shown in example equation X, a negative sign may indicate an inverse relationships between DI and TS: a high DI may lead to a low TS:

$$\frac{{\partial }_{TS}}{{\partial }_{DI}} = - 1 \cdot ( 100 - R S ) \qquad ( Equation X )$$

A relationship between risk indicator TS and RS for a case RS(1)>RS(2) may be expressed, e.g. according to example equations XI, XII, XIII and XIV:

$$TS 1 = ( 100 - R S ( 2 ) ) * ( 1 - D I ) \qquad ( Equation XI )$$

$$TS 2 = ( 100 - R S ( 2 ) ) * ( 1 - D I ) \qquad ( Equation XII )$$

$$TS 1 - TS \text{} 2 = [ \text{} ( 100 - R S ( 1 ) ) * ( 1 - D I ) ] - [ \text{} ( 100 - R S ( 2 ) ) * ( 1 - D I ) ] \qquad ( Equation XIII )$$

$$TS 1 - \text{} TS \text{} 2 = ( 100 - D I ) * ( R S ( 2 ) - R S ( 1 ) ) \qquad ( Equation XIV )$$

Under the assumption that RS(1)>RS(2), (RS(2)−RS(1))<0. Thus, a high RS may lead to low TS as illustrated in example equation XV:

$$( 100 - D I ) * ( R S ( 2 ) - R S ( 1 ) ) < 0 , \qquad ( Equation XV )$$

$$implies TS 1 < TS 2$$

A relationship between TS and DI may be illustrated according to example equations XVI and XVII:

$$TS 1 = ( 100 - RS ) * ( 1 - DI ( 1 ) ) \qquad ( Equation XVI )$$

$$TS 2 = ( 100 - RS ) * ( 1 - DU ( 1 ) ) \qquad ( Equation XVII )$$

Under the assumption that: DI(1)>DI(2), the difference between TS1 and TS2 can be expressed according to example equations XVIII and XIX:

$$( Equation XVIII )$$

$$TS 1 - TS 2 = [ ( 100 - RS ) * ( 1 - DI ( 1 ) ) ] - [ ( 100 - RS ) * ( 1 - DI ( 2 ) ) ]$$

$$TS 1 - TS 2 = ( 100 - RS ) * ( DI ( 2 ) - DI ( 1 ) ) \qquad ( Equation XVIX )$$

Thus, according to example equation XX, a high DI value may lead to a low TS value:

$$( 100 - RS ) * ( DI ( 2 ) - DI ( 1 ) ) < 0 , implies TS 1 < TS 2 \qquad ( Equation XX )$$

The previous example equations, may illustrate an example for a calculation of the trust indicator (TS) based on predefined rules and weighted risk factors. While this approach may provide a clear understanding of the trust assessment process, the possibility to scale the approach or to adapt it to dynamic data environments may be limited. A machine learning (ML) optimization method including a linear regression model may be used to provide a prediction of a trust indicator, allowing to scale the descripted method and, e.g. to adapt it to dynamic data environments, e.g. a dynamic data environment may be based on data which may be collected in a future data collection period, e.g. within the next year.

Based on provided training datasets, e.g. training datasets which include training coefficients ER_{W} and EDD_{W}, training risk factors ER_{RF} and/or EDD_{RF}, and training trust indicators, a ML model may be trained to predict a trust indicator (TS) for risk factors using a machine learning model, e.g. by identifying a linear relationship between risk factors and the trust indicator, which can be expressed according to example equation XXI:

$$TS = {coeff}_{ER}^{w} \cdot {E}_{RF} + {coeff}_{EDD}^{w} \cdot {EDD}_{RF} + b \qquad ( Equation XXI )$$

wherein:
TS may be the trust indicator to be predicted;
E_{RF} may be an array of one or more entity risk factors;
EDD_{RF} may be an array of one or more enhanced due diligence risk factors;

$${coeff}_{ER}^{w} and {coeff}_{EDD}^{w}$$

may be coefficients for the respective risk factors; and
b may be a bias term. bias b refers to a constant adjustment or influence applied to example equation XXI to ensure that the model fits the data accurately in the calculation of a TS. It can represent a baseline or starting point that is not directly influenced by other variables but is necessary to increase the accuracy in a model prediction.

Before applying a machine learning optimization, received data items may be pre-processed to ensure that they are suitable for modeling using a ML model. Pre-processing may involve one or more operations such as:
1. Calculation of E_{RF} score and EDD_{RF} score based on present risk factors and weights.
2. Creation of a feature matrix x by stacking the E_{RF} and EDD_{RF} arrays horizontally.
3. Reshaping x into a 2D array to meet the input requirements of the machine learning models.
4. Construction of the target vector y containing a trust indicator (TS) for each legal entity.

A linear regression model, e.g. a supervised learning technique that assumes a linear relationships between the input features and the target variable may be applied. A ML model may learn coefficients w₁ and w₂ and bias term b that best fit to the supplied training data sets. Training datasets may include training coefficients, training risk factors and training trust indicator. A ML model's prediction for a trust indicator TS may be calculated according to example equation XXII:

$$= {coeff}_{ER}^{w} \cdot {E}_{RF} + {coeff}_{EDD}^{w} \cdot {EDD}_{RF} + b \qquad ( Equation XXII )$$

To train the linear regression model, a fit method may be used, which adjust the ML model's parameters to minimize the mean squared error between the predicted Trust Scores [symbol] and the true Trust Scores TS. An optimization process may determine optimal values for coefficients w₁, w₂, and b as shown in example equation XXIII:

$$( {coeff}_{ER}^{w} , {coeff}_{EDD}^{w} , b ) = argmin {\sum }_{i = 1}^{N} {( {l}_{} - TS )}^{2} \qquad ( Equation XXIII )$$

Wherein N is the number of data points.

Once the model is trained, it can be used to predict trust indicators for new legal entities with given risk factors and weights. Predicted trust indicators [symbol] may be computed using the learned coefficients and the input risk factors. The accuracy and performance of the model can be assessed using various evaluation metrics such as Mean Squared Error (MSE), Root Mean Squared Error (RMSE), or R-squared.

Table 4 shows learned coefficients based on optimization method and may represent a comparison of predefined and learned weights, and assessment of data quality of the learned weights using standard evaluation methods such as area under the receiver operating characteristic curve (ROC curve) and precision-recall (PR) curve.

TABLE 4

| | | Predefined | Learned | | F1 | AUC ROC | PR- |
|---|---|---|---|---|---|---|---|
| | Metric | coeff | weights | intercept | score | curve | curve |
| 1 | coeff_{ER} | 0.70000 | 0.68000 | 0.05000 | 0.86000 | 0.92000 | 0.87000 |
| 2 | coeff_{EDD} | 0.30000 | 0.32000 | −0.05000 | 0.87000 | 0.93000 | 0.87000 |

Table 4 shows an example for generated coefficients coeff_{ER} and coeff_{EDD} in the calculation of a trust indicator TS. Entity risk factors and enhanced due diligence risk factors may be measured and combined to compute trust indicators (TS). The coefficients

$${coeff}_{ER}^{w} and {coeff}_{EDD}^{w}$$

may represent weights assigned to E_{RF} and EDD_{RF}, respectively, in the trust score calculation. These coefficients may be determined through machine learning optimization.

In the scenario illustrated by the data items disclosed in table 4, table 4 may illustrate the application of machine learning to optimize trust indicator calculations based on training datasets and coefficients that reflect the underlying relationships between risk factors and trust indicators.

Coefficients

$${coeff}_{ER}^{w} and {coeff}_{EDD}^{w}$$

may be learned coefficients obtained through machine learning optimization. These coefficients may be derived, e.g. from 1 million datasets of legal entities and reflect the relative importance of risk factors in determining trust scores.

Incorporating machine learning optimization into the trust indicator calculation process may provide several advantages: It may allow adapting the incorporation of risk factors into a trust score in view of changing data sources of risk factor data, potential improvements in predictive accuracy, and scalability to handle a larger number of legal entities. The formal framework described above may disclose the mathematical basis for this optimization approach and may provide a foundation for integrating machine learning into entity risk assessment systems.

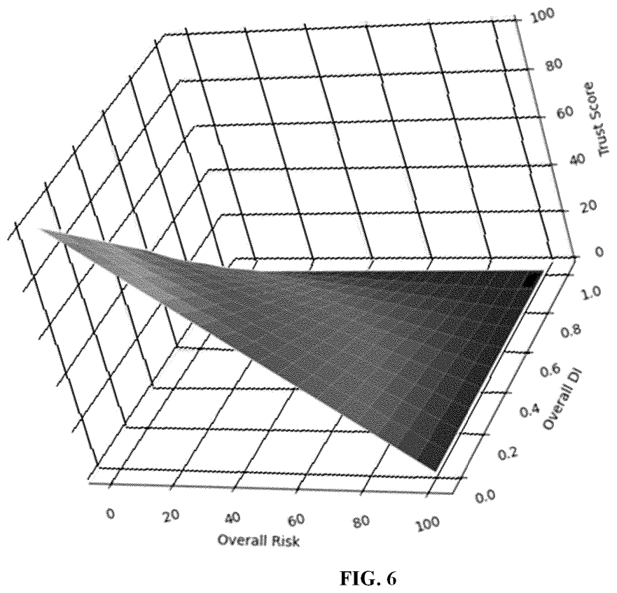

FIG. 6 is a visual representation of a risk score (overall risk) in relation to data incompleteness score (overall ID) and trust indicator (trust score), according to some embodiments of the present invention. Trust indicators may be ranked, e.g. a trust indicator of 80 may indicate no risk associated with a legal entity and a trust indicator of 15 may indicate a risk associated with a legal entity.

Analytical and visual proof of the mathematical equation for inverted risk and trust indicator relationships plot may indicate that the trust indicator shows a high value for cases when the overall risk (data incompleteness score DI) is decreased.

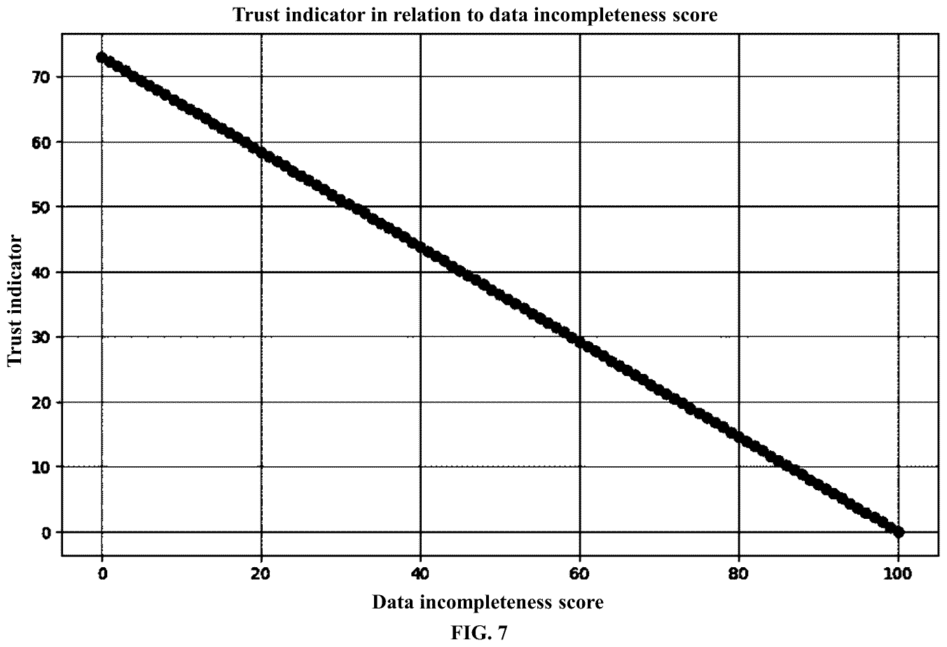

FIG. 7 is a graph illustrating a linear relationship between trust indicator in relation to data incompleteness score for a legal entity, according to some embodiments of the present invention. The plot may indicate an inverted linear relationships between the data incompleteness score per legal entity and its trust indicator. The plot was achieved by running simulation on the computational unit of the algorithm.

Generated trust indicators may be used in a number of ways, for example to assess whether or not a transaction scheduled for a legal entity can be processed, e.g. by a financial institution. For example, a threshold for a transaction may be set to automatically generate a trust indicator for a legal entity based on customizable event, e.g. a trust indicator may be automatically generated and assessed for legal entities taking part in a transaction which exceeds an amount of $100,000. In the case that a trust indicator exceeds a threshold value, e.g. 70 out of a score between 0 to 100 (0 being equivalent to the lowest and 100 being equivalent to the highest trust indicator), a transaction for a legal entity may be executed. In the case that a trust indicator does not exceed a threshold value, e.g. 70 out of a score between 0 to 100 (0 being equivalent to the lowest and 100 being equivalent to the highest trust indicator), a transaction for a legal entity may not be executed.

Data for a legal entity to identify risk factors for a legal entity may be retrieved, for example, from a legal entity's credit card, e.g. a card profiles and/or device profiles. Data retrieved for legal entities may affect risk score values, e.g. in case that it has been more than a year since a legal entity performed a transaction with an amount greater than $100,000, 10 points may be added to a RS in the trust indicator calculation.

In the retrieval of risk factors for a legal entity, identified legal entity activities, e.g. a web activity or web internal transfers, may be separated into multiple base activities. Base activities can represent a legal entity's most specific activity and determine which detection models may be calculated for assessing a legal entity conducting a transaction, e.g. whether or not trust indicators for a legal entity may be calculated for a specific transaction amount of a legal entity, e.g. $100,000. Each transaction may be mapped to one and only one base activity. A base activity may be calculated for each transaction. This default base activity is usually determined according to the channel, transaction type, additional fields, and calculations.

Analysts can set calculated variables using a comprehensive context, such as the current transaction, the history of the main entity associated with the transaction, the built-in model's results, etc. These variables can be used to create new indicative features. The variables can be exported to the detection log, stored in IDB 826, and exposed to users in user analytics contexts.

Transactions that satisfy certain criteria may indicate events that may be interesting for the analyst. The analyst can set events the system identifies and profiles when processing the transaction. This data can be used to create complementary indicative features (using the custom indicative features mechanism or structured model overlay (SMO)). For example, an analyst can define an event that says: amount>$100,000. The system profiles aggregations for all transactions that trigger this event (e.g., first time it happened for the transaction party etc.).

Once custom events are defined, an analyst can use predefined indicative feature templates to enrich built-in model results with new indicative feature calculations. Proceeding with the example from the custom events section, an analyst can now create an indicative feature that says, e.g. that if it has been more than a year since the customer performed a transaction with an amount greater than $100,000, then add 10 points to the RS in the trust indicator calculation.

SMO may be a framework in which an analyst may retrieve all outputs of built-in and custom analytics as input (such as the above) to enhance the detection results with issues and set the transaction's risk score.

Analytics logic may be implemented in two phases. Only a subset of the transactions may be passed on to the second phase, as determined by a filter.

A detection log may include transactions enriched with analytics data such as indicative features, results, and variables. An analyst can configure which data should be exported to the log and use it for pre- and post-production tuning.

A detection process may be triggered for each transaction. However, most of the analytics logic relates to legal entities rather than transactions. For example, all transactions for the same legal entity, party, trigger detection, whilst the detection logic is based on the party activity in the detection period.

A transaction detection flow may include multiple steps, data retrieval for detection (detection period sets and profile data for the legal entity), variable calculations, Analytics models may include different indicative feature instances, and SMO (structured model overlay).

For performance reasons, a detection flow for transactions may be divided into two phases, phase A and phase B. Analytics logic may be run after phase A to decide whether it is necessary to run phase B. The decision not to proceed to phase B may be due to two reasons: either a transaction is suspicious, or the transaction is not suspicious. If it is not yet clear whether or not a transaction is suspicious, processing continues with phase B detection.

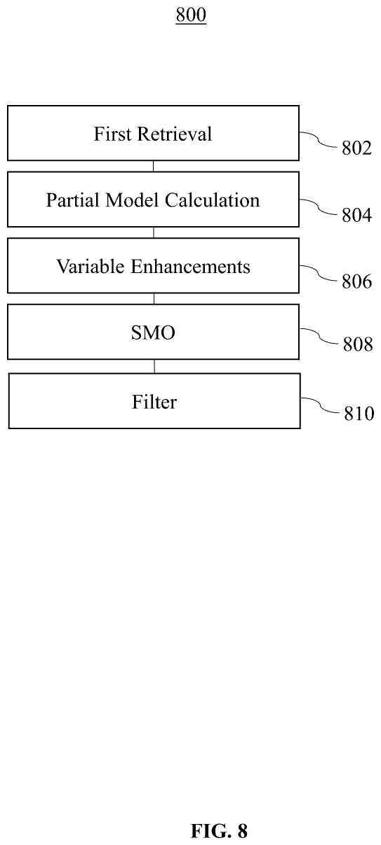

FIG. 8 is a schematic illustration of a first detection flow 800 for data items used in the generation of risk factors, according to some embodiments of the present invention.

In a first retrieval operation 802, profiles and accumulation period data needed for the detection may be retrieved; for example, for a credit card, it may retrieve card profiles and device profiles and the previous activity by card set. The retrieved data may be used in a policy manager.

In operation partial model calculation 804, custom events may be used to calculate a risk score (RS).

In operation variable enhancements 806, analytics can use to enrich the out-of-the-box models (internal indicative features and indicative custom features) and override a risk score.

In operation 808, an SMO model may be generated.

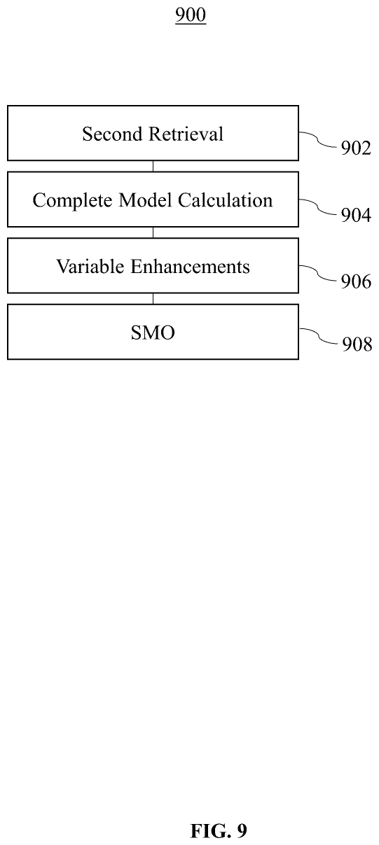

In operation 810, a filter assessment may be used to assess whether or not to proceed to phase B shown in FIG. 9. A filter may have two parts, out-of-the-box, and custom. An AIS exit point may be implemented in the filter.

FIG. 9 is a schematic illustration of a second detection flow 900 for data items used in the generation of risk factors, according to some embodiments of the present invention.

In second retrieval operation 902, data needed for the calculation of a risk indicator may be retrieved based on more complex queries compared to retrieval operation 932, for example, multiple payees per transaction.

In operation complete model calculation 904, an additional calculation of internal and custom indicative features may be generated.

In operation variable enhancements 906, additional calculations may be conducted based on newly retrieved sets.

In operation SMO 908, a final score for a transaction of a legal entity may be calculated. This can be based on further models.

Activities may be used to logically group events in the client's systems:

Each channel may be an activity, for example, a Web activity.

Each type of service may be an activity, for example, an internal transfer activity.

Each combination of an activity and a type of service may be an activity, for example, Web Internal Transfer Activity.

Activities can span multiple channels and services, for example, a transfer activity, which is any activity that results in a transfer.

Transactions can be associated with multiple activities.

Activities may be separated into multiple base activities. Base activities can represent a legal entity's most specific activity and determine which detection models may be calculated for a transaction. Each transaction may be mapped to one and only one base activity.

An embodiment may calculate a base activity for each transaction. This default base activity is usually determined according to the channel, transaction type, additional fields, and calculations.

A base activity of a transaction for a legal entity may be set by combining a channel type and an transaction type, e.g. as mapped in a data integration. The definition of some base activities may be based on the value of an additional field or a calculated indicator, as detailed in the tables in this section.

For an acquirer, a base activity may be generally calculated by combining a channel type, the message purpose, and additional fields, as detailed in the relevant tables.

Data pre-processing of a transaction following the assessment of a risk indicator may include for example:
a. Check IFM filtration
b. Should the model refer to all or only some of the events
   i. Add/edit payee
   ii. Reject notifications
   iii. Account service events
c. Are the differences at data mapping for different types of events
d. Is versioning in scope
e. Which events/versions the Financial Institution (FI) is alerting/blocking

For each transaction, a fraud review may be conducted prior to initiating the transactions. Factors that may impact the quality of the fraudulent dataset include, for example:
1. Partial data—the provided fraud report is based on one system, but the client is using a few other systems to monitor fraud data
2. Only alerted transactions were included with no missing fraud—that will impact the ability of the tuned model to learn from the current model's weakness
3. Wrong fraud tagging did by the fraud investigators
4. Purpose of Fraud Enrichment:
5. Increase the volume of the fraudulent dataset—more samples to learn from
6. Lower the risk of wrongly categorizing fraudulent transactions as ‘Clean’ and vice versa
7. Used as a tool to review the quality of the fraudulent dataset-if the number of enriched transactions is relatively high, it is suspicious
8. Basic Fraud Enrichment criteria:
9. Same Party, Same Payee
10. Same Device, Same Payee, other parties

In case of a detected inconsistency, the transaction may be excluded from both clean and fraud datasets.

In the processing of a transaction, data mapping and validation documents may be assessed for a transaction and data elements associated with wrong mapping or known data issues may be excluded, for example:
1. Exclude all keys fields such as party-Key
2. Exclude all scrambled fields. If a meaningful field is found to be scrambled—discuss it with PS/Product team so that scrambling will be removed before the next tuning
3. Exclude PM Operational fields—those are not available in real-time.
4. Review data elements that populated only for a small fraction of the population—is it a true ‘rare’ feature/value, or perhaps it is caused by a data issue? Furthermore, it is recommended to exclude ‘suspicious’ features (lift>1) that got populated by less than 50 fraudulent transactions.
5. Exclude features from an external scoring system or an external list such as ‘External Score 1’ or ‘External High Focus Payee’—it's better to avoid a dependency between Actimize's model and external systems, which might change in the future. Those types of features can be used in PM rules.
6. Better to avoid features with a very specific ‘short life’ value such as specific geographical region, specific IP address, or specific amount values—Fraudsters are smart and quick to respond!
7. Calculate the time difference between different date fields, such as the last password change date and the transaction's date
8. Feature engineering—transactional raw data may be used.

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

What is claimed is:

1. A method of determining trust indicators, the method comprising:
determining coefficients for a plurality of risk factors for a legal entity,
wherein said risk factors indicate risks associated with one or more of: said legal entity taking part in a transaction and said legal entity's transaction type, and
wherein said coefficients determine a relative impact of each of said plurality of risk factors in the calculation of a risk score for said legal entity;
calculating said risk score from coefficients and risk factors;
assessing data incompleteness for values of said plurality of risk factors and calculating a data incompleteness score; and
generating a trust indicator for said legal entity from said risk score and data incompleteness score.

2. A method according to claim 1, wherein when said trust indicator is <than a threshold value, blocking said legal entity associated with said trust indicator from executing a transaction.

3. A method according to claim 1, wherein when said trust indicator is >=than a threshold value, permitting said legal entity associated with said trust indicator to execute a transaction.

4. A method according to claim 1, wherein said coefficients are updated by submitting previously recorded combinations of coefficients and risk scores to a machine learning (ML) model and retrieving updated coefficients.

5. A method according to claim 4, wherein said ML model is trained by operations comprising:
receiving, by a processor, training datasets comprising training coefficients, training risk factors and training trust indicators; and
training, by the processor, said ML model using said training datasets to determine said training coefficients from said training trust indicators and said training risk factors.

6. A method according to claim 4, wherein said updating of said coefficients via said ML model comprises submission of previously recorded combinations of coefficients and risk scores to a ML model comprising a linear regression model.

7. A method according to claim 1, wherein said trust indicator (TS) is calculated from said risk score (RS) and said data incompleteness score (DI) according to equation I:
$$= ( 100 - RS ) \cdot ( 1 - DI ) \qquad Equation I$$

8. A method according to claim 1, wherein said plurality of risk factors comprises one or more entity risk factors (E_{RF}) and one or more enhanced due diligence risk factors (EDD_{RF}) and said risk score (RS) is calculated according to equation II:
$$RS = {coeff}_{ER}^{w} \cdot {E}_{RF} + {coeff}_{EDD}^{w} \cdot {EDD}_{RF} \qquad Equation II$$
wherein:
RS is the risk score to be determined;
E_{RF} is an array of said one or more entity risk factors;
EDD_{RF} is an array of said one or more enhanced due diligence risk factors; and
$${coeff}_{ERF}^{w} and {coeff}_{DDRF}^{w}$$
are coefficients for the respective risk factors.

9. A method according to claim 8, wherein determining trust indicators comprises:
calculating said E_{RF} and EDD_{RF} arrays;
creating a feature matrix from said E_{RF} and EDD_{RF} arrays
converting said feature matrix into a 2-dimensional array; and
constructing a target vector containing said trust score.

10. A method according to claim 1, comprising evaluating said trust indicator using an evaluation metric selected from a group consisting of mean squared error, root mean squared error (RMSE) and r-squared error.

11. A system for determining trust indicators of legal entities, the system comprising:
a computing device;
a memory; and
a processor, the processor configured to:
determine coefficients for a plurality of risk factors for a legal entity,
wherein said risk factors indicate risks associated with one or more of: said legal entity taking part in a transaction and said legal entity's transaction type, and
wherein said coefficients determine a relative impact of each of said plurality of risk factors in the calculation of a risk score for said legal entity;
calculate said risk score from coefficients and risk factors;
assess data incompleteness for values of said plurality of risk factors and calculate a data incompleteness score; and
generate a trust indicator for said legal entity from said risk score and data incompleteness score.

12. A system according to claim 11, wherein when said trust indicator is <than a threshold value, the processor is configured to block said legal entity associated with said trust indicator from executing a transaction.

13. A system according to claim 11, wherein when said trust indicator is >=than a threshold value, the processor is configured to permit said legal entity associated with said trust indicator to execute a transaction.

14. A system according to claim 11, wherein said coefficients are updated by submitting previously recorded combinations of coefficients and risk scores to a machine learning (ML) model and retrieving updated coefficients.

15. A system according to claim 14, wherein said ML model is trained by operations comprising:
receiving, by a processor, training datasets comprising training coefficients, training risk factors and training trust indicators; and
training, by the processor, said ML model using said training datasets to determine said training coefficients from said training trust indicators and said training risk factors.

16. A system according to claim 14, wherein said updating of said coefficients via said ML model comprises the submission of previously recorded combinations of coefficients and risk scores to a ML model comprising a linear regression model.

17. A system according to claim 11, wherein said trust indicator (TS) is calculated from said risk score (RS) and said data incompleteness score (DI) according to equation I:
$$= ( 100 - RS ) \cdot ( 1 - DI ) \qquad Equation I$$

18. A system according to claim 11, wherein said plurality of risk factors comprises one or more entity risk factors (E_{RF}) and one or more enhanced due diligence risk factors (EDD_{RF}) and said risk score (RS) is calculated by equation II:
$$RS = {coeff}_{ER}^{w} \cdot {E}_{RF} + {coeff}_{EDD}^{w} \cdot {EDD}_{RF} \qquad Equation II$$
wherein:
RS is the risk score to be determined;
E_{RF} is an array of said one or more entity risk factors;
EDD_{RF} is an array of said one or more enhanced due diligence risk factors; and
$${coeff}_{ERF}^{w} and {coeff}_{DDRF}^{w}$$
are coefficients for the respective risk factors.

19. A system according to claim 18, wherein the processor is configured to determine trust indicators by the operations comprising:
calculating said E_{RF} and EDD_{RF} arrays;
creating a feature matrix from said E_{RF} and EDD_{RF} arrays
converting said feature matrix into a 2-dimensional array; and
constructing a target vector containing said trust score.

20. A method of generating trust indicators for actions of corporate bodies, the method comprising:
determining weights for a plurality of risk factors for a corporate body,
wherein said risk factors indicate risks associated with one or more of: said corporate body taking part in a transaction and said corporate body's transaction type, and
wherein said weights determine a relative impact of each of said plurality of risk factors in the calculation of a risk score for said corporate body;
calculating said risk score from weights and risk factors;
identifying data completeness for values of said plurality of risk factors and calculating a data completeness score; and
generating a trust indicator for said corporate body from said risk score and data completeness score.
